(19) United States
(12) Patent Application Publication
(10) Pub. No.: US 2005/0051738 A1
(43) Pub. Date: Mar. 10, 2005

(54) Process and apparatus for retrieving information projected image-wise on a photo-stimulable phosphor imaging substrate

(76) Inventors: Edgar Alzner, Garden City, NY (US); Yehuda Rosenstock, Freeport, NY (US)

Correspondence Address: CLIFFORD G. FRAYNE, Suite 7A, 136 Drum Point Road, Brick, NJ, 08723, US

(21) Appl. No.: 10/933,648

(22) Filed: Sep. 3, 2004

Related U.S. Application Data
(60) Provisional application No. 60/500,794, filed on Sep. 8, 2003.

(51) Int. Cl. G03B 42/08

(52) U.S. Cl. 250/484.4

(57) ABSTRACT

These and other objects of the present invention are achieved by a process and apparatus for interrogating or scanning a photo-stimulable phosphor substrate containing projected image-wise information wherein a laser beam is directed towards a lens to produce a planar light beam directed onto the storage substrate as a focused light line to stimulate luminescent information detected by a linear sensor for collection and transmission to a computer assembly.

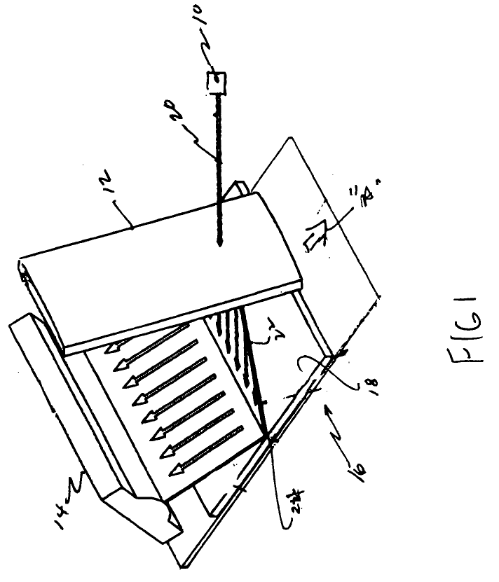

### RELATED APPLICATIONS

Applicant claims the benefit of provisional application 60/500,764, filed Sep. 8, 2003.

### BACKGROUND OF THE INVENTION

1. Field of the Invention

This invention relates to radiographic imaging, and more particularly to a process and apparatus for digitally retrieving information projected onto a photo-stimulable phosphor imaging substrate.

2. Description of the Prior Art

Traditional x-ray imaging systems using silver-based films are being replaced by radiographic imaging systems using photo-stimulable phosphor imaging substrates or films eliminating the need for physical storage of the resulting imaged film since digital retrieval of the image information includes input and computer storage permitting viewing of such information on a viewer, such as CRT tube assembly. Additionally, such computer stored image information permits facile electronic transmission to any preselect location obviating physical transfer of the thus formed image as developed on the imaging film.

In U.S. Pat. No. 5,874,744 to Goodman, et al., assigned to the same assignee as the present invention herein incorporated by reference, there is disclosed a process and apparatus for processing radiographic information from an anisotropic storage phosphor screen including an opto-electro-mechanical assembly to achieve raster scan of an interrogating beam and including detector and computer assembly.

The prior art is replete with a plethora of radiographic imaging information assemblies for reading projected image-wise information from a photo-stimulable phosphor sheet, film or substrate, e.g. see U.S. Pat. No. 6,624,457 to Kohada wherein excitation light emits photostimulated luminescent light from the stored energy of the projected image-wise information film. In such disclosure, the plate, film, sheet or substrate is disposed on a horizontal support surface and screened by an excitation scanning assembly including a laser beam. See also U.S. Pat. No. 4,676,582 to Kato, et al.

In U.S. Pat. No. 6,599,004 to Thoms, there is disclosed a device for reading flexible storage films wherein the flexible storage film having image-wise projected information is positioned on a cylindrically-shaped surface and is caused to be linearly moved there over while being interrogated or scanned via a slot by a light beam generated in a helical line in a continuous manner from a point disposed at the axis of the cylindrically-shaped surface.

There are a plethora of disclosures relating to retrieving information from a cylindrically disposed image-wise containing storable phosphor film or substance, e.g. U.S. Pat. No. 4,302,671 to Kato, et al. All such disclosures use a stimulating light beam as an element of an opto-mechanical assembly to interrogate and scan an image-wise storable phosphoric film. Such opto-mechanical assemblies must be accurately designed to reliably provide useful information, and as appreciated by those skilled in the art, must be precisely manufactured and calibrated to produce useful results given the micro-scanning requirements. Consequently, such opto-mechanical assemblies are costly and require excessive spacial designs.

As used herein, the term “storage substrate” is a film plate or sheet indicating photo-stimulable phosphors and is capable of being imaged with ionizing radiation or x-rays which after imaging may be interrogated or scanned with a source of light energy to produce photostimulated luminescence information capable of being digitally read and stored.

### OBJECTS OF THE INVENTION

An object of the present invention is to provide an improved process and apparatus for interrogating or scanning a photo-stimulable phosphor substrate.

Another object of the present invention is to provide an improved process and apparatus for interrogating or scanning a photo-stimulable phosphor substrate of improved speed and resolution.

Yet another object of the present invention is to provide an improved process and apparatus for interrogating or scanning a photo-stimulable phosphor substrate obviating costly and complex opto-mechanical assemblies.

A still further object of the present invention is to provide an improved process and apparatus for interrogating or scanning a photo-stimulable phosphor substrate of reduced size requirements.

### SUMMARY OF THE INVENTION

These and other objects of the present invention are achieved by a process and apparatus for interrogating or scanning a photo-stimulable phosphor substrate containing projected image-wise information wherein a laser beam is directed towards a lens to produce a planar light beam directed onto the storage substrate as a focused light line to stimulate luminescent information detected by a linear sensor for collection and transmission to a computer assembly.

### BRIEF DESCRIPTION OF THE DRAWINGS

Further objects and advantages of the present invention will become more readily apparent by reference to the following detailed description thereof when taken with the accompanying drawing wherein like numerals designate like parts throughout and wherein the FIGURE is a somewhat schematic perspective view of the process and apparatus of the present invention.

### DETAILED DESCRIPTION OF THE PRESENT INVENTION

Referring now to the drawing, there is illustrated the principle elements of the process and apparatus of the present invention comprised of a source of laser light source 10, a cylindrical lens 12, a linear light detector 14 and a horizontal and a transport assembly, generally indicated as 16 for positioning a photo-stimulable phosphor substrate 18 having a projected image formed thereon as more fully hereinafter described. It is understood to one skilled in the art that the elements are positioned within a suitable housing assembly (not shown) having a slot for inserting a storage substrate and an appropriate exit slot for withdrawing the scanned storage substrate. The transport assembly 16 may include roller and belt assemblies, such as disclosed in the aforementioned U.S. Patent to Thoms, however configured in horizontal array.

The laser light source 10 is disposed to direct a laser beam 20 to the cylindrical lens 14 dimensioned to produce a planar light beam 22 (indicated by the arrows) for projection as a focused light line 24 on the photo-stimulable substrate 18 being processed. The light line 24 is caused to be projected in a plane parallelledly disposed to the plane of the photo-stimulable phosphor substrate 18 being moved on the transport assembly 16. Intensity energy level of the laser beam 10 is at a level adequate to produce a light line 22 after passage through the lens 12 at an intensity level sufficient to stimulate the light energy stored on the photo-stimulable phosphor substrate 18. In this respect, such intensity level is significantly greater than an intensity level of a light beam required for point by point scanning as herein above referenced. Additionally the cylindrical lens 14 is preferably dimensioned to form a light line 22 of like height to the diameter of the laser beam 20, although such dimensioned relationship may be varied as a function of desired resolution information to be retrieved, as more fully hereinafter discussed.

Photo-stimulable luminescent light generated at the contact line 24 is detected by the light detector 14, as illustrated by arrows on the plane 26 including for example CCD elements, and processed, such as disclosed in the aforementioned U.S. Patent to Goodman, et al. It will be understood that positioning of the light detector 14 in the housing is for most efficacious detections and collection of the photo-stimulable luminescent light, as understood by one skilled in the art not in reflection as suggested by the plane 26 and accompanying arrows, in order to facilitate an understanding of the invention.

In operation, a photo-stimulable phosphor substrate 18 having a projected image thereon for scanning is positioned proximate the entry slot as hereinabove discussed and sensed to cause the transport assemblies to move the substrate along a horizontal plane into the housing assembly. The storage substrate is moved in a direction indicated by the arrows “A” in essentially perpendicular relationship to the plane of the planar light beam 22 and the resulting contact light line 24 to effect photo-stimulable luminescence, as herein above discussed.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

1. A process for scanning a photo-stimulable phosphor substrate having an image projected thereon with a laser beam from a light source capable of producing photo-stimulable luminescent light from stored energy of the projected image-wise information which is detected, collected and stored in a computer assembly which comprises:
directing a laser beam of said light source to and through a lens to generate a planar light line to be focused as a light line on said photo-stimulable phosphor substrate to generate luminescent light representative of said stored energy of said projected image-wise information; and
transporting said substrate through said planar light line to retrieve said projected image.

2. The process for scanning a photo-stimulable phosphor substrate as defined in claim 1 wherein intensity of said light source is adjusted to compensate for energy losses during passage through said lens to provide an energy level of said focused light line of sufficient to excite stored energy of said projected image to a level to produce said luminescent light.

3. The process for scanning a photo-stimulable phosphor substrate in accordance with claim 1 wherein said focused plane light line is in a plane parallelledly disposed to a plane of said transported substrate.

4. The process for scanning a photo-stimulable phosphor substrate in accordance with claim 1 wherein dimensional height of said focused light line is of like dimension as said laser beam.

5. In an apparatus for scanning a photo-stimulable phosphor substrate having an image projected thereon with a laser beam from a light source capable of stimulating photo-stimulable luminescent light from stored energy of the projected image-wise information which is detected, collected and stored on a computer assembly, the improvement which comprises:
a transport means for moving said substrate in planar relationship through said apparatus; and
a lens means for forming a planar light beam directed to said substrate to form a light line thereon to generate luminescent light representative of said stored energy of said projected image-wise information.

6. The apparatus for scanning a photo-stimulable phosphor substrate as defined in claim 5 wherein said lens generates said light line of like dimension to said laser beam.

7. The apparatus for scanning a photo-stimulable phosphor substrate as defined in claim 5 wherein said lens generates said light line at least like dimension to a width of said substrate being processed.

8. The apparatus for scanning a photo-stimulable phosphor substrate as defined in claim 5 wherein said transport means moves said photo-stimulable phosphor substrate in parallelledly relationship to said light line through said apparatus.
